(19) United States
(12) Patent Application Publication
(10) Pub. No.: US 2005/0228637 A1
(43) Pub. Date: Oct. 13, 2005

(54) Universal translator/converter

(76) Inventor: Carla Lee Mae Clark, Barstow, CA (US)

Correspondence Address: Carla Lee Mae Clark, 37163 Camarillo Ave, Barstow, CA, 92311, US

(21) Appl. No.: 10/823,801

(22) Filed: Apr. 13, 2004

(51) Int. Cl. G06F 17/28

(52) U.S. Cl. 704/2

(57) ABSTRACT

The Universal Translator/Converter bridges the gap in the areas of language and communication. The invention is a portable hand-held device that is spoken into. It then translates the spoken language into whatever language that is needed in the form of a voice. It will wait for a response in the foreign language and convert the foreign language back into English. Thus, enabling the parties to freely converse with each other. This invention can convert and/or translate all languages in to the English language and visa versa. The undersigned has not developed, experimented on the design or tried to find a manufacture that will design or build the invention stated above. After, the invention is patented the undersigned will do further research and find a manufacture to design and promote the invention. The hand held portable translator/converter translates the English language into another language such as; Spanish Arabic, Japanese, Chinese, Cambodian, French, German, Hebrew, Latin, Russian, Vietnamese, Yugoslav, Tagolog or Hawaiian. It then converts the foreign language back into the English language, so the operator of the devise can hold a conversation with a non-English speaking person. It is not known by the undersigned if such technology currently exists but it is evident that the field of technology is ever changing and expanding. This invention can be utilized by different occupations, schools, military, and in the public sector to bridge the gaps and deficits in language and communications locally and world-wide. This would put the United States at an advantage and is more cost efficient.

### BACKGROUND OF INVENTION

The universal translator/converter translates the English language into another language such as; Spanish, Arabic, Japanese, Chinese, Cambodian, French, German, Hebrew, Latin, Russian, Vietnamese, Yugoslav, Tagolog or Hawaiian. It then converts the foreign language back into the English language, so the operator of the devise can hold a conversation with a non-English speaking person. It is not known by the undersigned if such technology currently exists but, it is evident that the field of technology is ever changing and expanding.

### BRIEF SUMMARY OF THE INVENTION

The hand held portable translator/converter translates the English language into another language such as; Spanish Arabic, Japanese, Chinese, Cambodian, French, German, Hebrew, Latin, Russian, Vietnamese, Yugoslav, Tagolog or Hawaiian. It then converts the foreign language back into the English language, so the operator of the devise can hold a conversation with a non-English speaking person. It is not known by the undersigned if such technology currently exists but, it is evident that the field of technology is ever changing and expanding. This invention can be utilized by different occupations, schools, military, and in the public sector to bridge the gaps and deficits in language and communications locally and worldwide. This would put the United States at an advantage and is more cost efficient.

### DETAILED DESCRIPTION OF THE INVENTION

The Universal Translator/Converter bridges the gap in the areas of language and communication. The invention is a portable hand-held device that is spoken into. It then translates the spoken language into whatever language that is needed in the form of a voice. It will wait for a response in the foreign language and convert the foreign language back into English. Thus, enabling the parties to freely converse with each other. This invention can convert and/or translate all languages in to the English language. The undersigned has not developed, experimented on the design or tried to find a manufacture that will design or build the invention stated above. After, the invention is patented the undersigned will do further research and find a manufacture to design and promote the invention.

1. What I claim as my invention is the Universal Translator/Converter. The Universal Translator/Converter bridges the gap in the areas of language and communication. The invention is a portable hand-held device that is spoken into. It then translates the spoken language into whatever language that is needed in the form of a voice. It will wait for a response in the foreign language and convert the foreign language back into English. Thus, enabling the parties to freely converse with each other. This invention can convert and/or translate all languages in to the English language and visa versa. The undersigned has not developed, experimented on the design or tried to find a manufacture that will design or build the invention stated above. After, the invention is patented the undersigned will do further research and find a manufacture to design and promote the invention.
